(19) United States
(12) Patent Application Publication
(10) Pub. No.: US 2021/0149195 A1
(43) Pub. Date: May 20, 2021

(54) DISPLAY APPARATUS AND DISPLAY CONTROL METHOD

(71) Applicant: SAMSUNG ELECTRONICS CO., LTD., Suwon-si (KR)

(72) Inventors: Daesu CHOI, Suwon-si (KR); Jigwang Kim, Suwon-si (KR); Jiwon Kim, Suwon-si (KR); Jaemin Soh, Suwon-si (KR); Kyehoon Lee, Suwon-si (KR); Sanghoon Lee, Suwon-si (KR)

(73) Assignee: SAMSUNG ELECTRONICS CO., LTD., Suwon-si (KR)

(21) Appl. No.: 17/095,872

(22) Filed: Nov. 12, 2020

(30) Foreign Application Priority Data
Nov. 18, 2019 (KR) 10-2019-0148085

(51) Int. Cl. G02B 27/01; G02B 17/00; G02B 5/10

(52) U.S. Cl. CPC G02B 27/0101; G02B 17/008; G02B 2027/0196; G02B 2027/013; G02B 2027/0185; G02B 5/10

(57) ABSTRACT

A display apparatus and a display control method are provided. The display apparatus includes: an image source configured to output a first image; a relay optics component configured to change a size of the first image and to transfer the first image; a surrounding structure provided around the image source or the relay optics component, and including a second image of a surrounding object; and a combiner configured to form a first virtual image by reflecting the first image, and to form a second virtual image around the first virtual image by reflecting the second image.

### CROSS-REFERENCE TO RELATED APPLICATION

This application is based on and claims priority under 35 U.S.C. § 119 to Korean Patent Application No. 10-2019-0148085, filed on Nov. 18, 2019, in the Korean Intellectual Property Office, the disclosure of which is incorporated by reference herein in its entirety.

### BACKGROUND

### 1. Field

The disclosure relates to a display apparatus and a display control method.

### 2. Description of Related Art

As an example of a display apparatus, a head up display (HUD) apparatus is well known.

The HUD apparatus may be used for augmented reality (AR), and most optical devices (glass, transparent mirrors, etc.) at the final stage seen by the human eye are manufactured to be transparent. An image generated by the HUD apparatus may be combined with an external landscape viewed through a transparent optical device to generate a meaningful image or the HUD image is viewed while viewing the external landscape.

For example, in a HUD apparatus applied to an existing aircraft or vehicle, a mirror (glass) of the final stage at which a virtual image is generated is manufactured as a transparent or partially light-transmitting optical device through which users may see the surrounding environment (landscape) simultaneously.

### SUMMARY

Provided are a display apparatus that allows a user to correctly recognize the size and distance of a virtual image by the design of a virtual image optical system and a display control method.

Additional aspects will be set forth in part in the description which follows and, in part, will be apparent from the description, or may be learned by practice of the presented embodiments of the disclosure.

In accordance with an aspect of the disclosure, a display apparatus includes an image source configured to output a first image; a relay optics component configured to change a size of the first image and to transfer the first image; a surrounding structure provided around the image source or the relay optics component, and including a second image of a surrounding object; and a combiner configured to form a first virtual image by reflecting the first image, and to form a second virtual image around the first virtual image by reflecting the second image.

The first virtual image may have a first magnification size at a virtual image distance of the first virtual image, the surrounding structure may be provided around a screen of the image source, the second image may have a second magnification size with respect to an original size of the surrounding object, and the second magnification size is reciprocal to the first magnification size.

The surrounding structure may be configured to surround a perimeter of the screen of the image source.

The image source may include an image panel, and the surrounding structure may include a holder of the image panel.

The relay optics component may include a convex mirror configured to magnify and reflect the first image, and the surrounding structure may include a holder of the convex mirror.

The surrounding structure may be configured to surround a circumference of the convex mirror.

The second image may include an image of any one of a clock, a frame, a tree, a flower pot, a curtain, a person, an animal, a wallpaper, a floor, a block, and a tile.

The display apparatus may further include a surrounding light source configured to emit a surrounding light around the surrounding structure.

The surrounding structure may include a step formed to protrude from a screen of the image source.

The surrounding structure may be continuously formed without a step with respect to a screen of the image source.

The surrounding structure may be configured to operate in a first mode of protruding from a screen of the image source with a step and in a second mode of being continuously formed without the step, and the first mode and the second mode are switchable.

The second virtual image may include a black color while the surrounding structure operates in the second mode.

The combiner may include a partially transparent concave mirror.

In accordance with an aspect of the disclosure, a display apparatus includes an image source configured to output a first image; a relay optics component configured to change a size of the first image and transfer the first image; a surrounding light source provided around the image source or the relay optics component and configured to emit a surrounding light; and a combiner configured to form a first virtual image by reflecting the first image transferred from the relay optics component; and form a second virtual image around the first virtual image by reflecting the surrounding light.

The surrounding light source may include a plurality of point light sources or continuous line light sources.

A shape of the surrounding light source may include a reduced shape of a surrounding object.

In accordance with an aspect of the disclosure, a display apparatus includes an image source configured to output an image; a relay optics component configured to change a size of the image and transfer the image; and a combiner configured to form a virtual image by reflecting the image, wherein a screen of the image source may include a first region configured to display content and a second region located around the first region and configured to display an image of a surrounding object.

The first region may be located at a center of the screen, and the second region may surround a perimeter of the first region.

A first virtual image of the first region may have a first magnification size at a virtual image distance of the first virtual image, the image of the surrounding object may have a second magnification size with respect to an original size of the surrounding object, and the first magnification size is a reciprocal of the second magnification size .

In accordance with an aspect of the disclosure, a display control method includes outputting an image; transferring the image using a relay optics component; forming a first virtual image by reflecting the image by using a combiner; and forming a second virtual image including a shape of a surrounding object around the first virtual image using the combiner.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram illustrating a display apparatus according to an embodiment;

FIG. 2 is a schematic partial cross-sectional view illustrating the display apparatus of FIG. 1 according to an embodiment;

FIG. 3 is a schematic diagram illustrating an optical system of the display apparatus of FIG. 1 according to an embodiment;

FIG. 4 is a schematic diagram illustrating a surrounding structure according to an embodiment;

FIG. 5 is a schematic diagram illustrating virtual images that a user sees through a display apparatus according to an embodiment;

FIG. 6 is a schematic cross-sectional view of a surrounding structure according to an embodiment;

FIG. 7 is a schematic cross-sectional view of a surrounding structure according to an embodiment;

FIG. 8 is a schematic cross-sectional view of a surrounding structure according to an embodiment;

FIG. 9A is a schematic diagram illustrating an image of a surrounding environment of a surrounding structure, according to an embodiment;

FIG. 9B is a schematic diagram illustrating an image of a surrounding environment of a surrounding structure, according to an embodiment;

FIG. 9C is a schematic diagram illustrating an image of a surrounding environment of a surrounding structure, according to an embodiment;

FIG. 10 is a schematic partial cross-sectional view of a display apparatus according to an embodiment;

FIG. 11 is a diagram illustrating an image source and a surrounding light source of a display apparatus, according to an embodiment;

FIG. 12 is a diagram illustrating an image source and a surrounding light source of a display apparatus, according to an embodiment;

FIG. 13 is a diagram illustrating an image source of a display apparatus, according to an embodiment;

FIG. 14 is a schematic block diagram illustrating a display apparatus according to an embodiment;

FIG. 15 is a schematic block diagram illustrating a display apparatus according to an embodiment;

FIG. 16 is a schematic flowchart illustrating a display method according to an embodiment; and

FIG. 17 is a schematic flowchart illustrating a display method according to an embodiment.

### DETAILED DESCRIPTION

Hereinafter, one or more embodiments of the disclosure will be described in detail with reference to accompanying drawings. In the drawings, like reference numerals denote like components, and sizes of components in the drawings may be exaggerated for convenience of explanation. Meanwhile, the embodiments of the disclosure described below are merely exemplary, and various modifications are possible from these embodiments of the disclosure.

Although the terms used the embodiments of the disclosure are selected from among common terms that are currently widely used in consideration of their functions in the disclosure, the terms may vary according the intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

An expression used in the singular encompasses the expression of the plural, unless it has a clearly different meaning in the context. Throughout the disclosure, when a portion “includes” an element, another element may be further included, rather than excluding the existence of the other element, unless otherwise described.

Throughout the disclosure, the expression “at least one of a, b or c” indicates only a, only b, only c, both a and b, both a and c, both b and c, all of a, b, and c, or variations thereof.

In addition, the terms such as “. . . unit”, etc. provided herein indicates a unit performing at least one function or operation, and may be realized by hardware, software, or a combination of hardware and software.

The expression “configured to (or set to)” used herein may be replaced with, for example, “suitable for,” “having the capacity to,” “designed to,” “adapted to,” “made to,” or “capable of” according to cases. The expression “configured to (or set to)” may not necessarily mean “specifically designed to” in a hardware level. Instead, in some cases, the expression “system configured to . . . ” may mean that the system is “capable of . . . ” along with other devices or parts. For example, “a processor configured to (or set to) perform A, B, and C” may refer to a dedicated processor (e.g., an embedded processor) for performing a corresponding operation, or a general-purpose processor (e.g., a central processing unit (CPU) or an application processor (AP)) capable of performing a corresponding operation by executing one or more software programs stored in a memory.

In the disclosure, the term ‘virtual image’ means a case where light is not actually present on a place where an image is formed by an optical system. In the case of a concave mirror, an erect virtual image is formed when an object is present inside the focal point of the concave mirror. Even when a real image is formed inside the focal point of the concave mirror by another optical system, an image of the real image is formed by the concave mirror.

In the disclosure, the term ‘display apparatus’ is a virtual image display apparatus capable of expressing an image using a virtual image optical system and includes a vehicle head up display (HUD) and an aircraft HUD as well as an indoor and outdoor entertainment HUD.

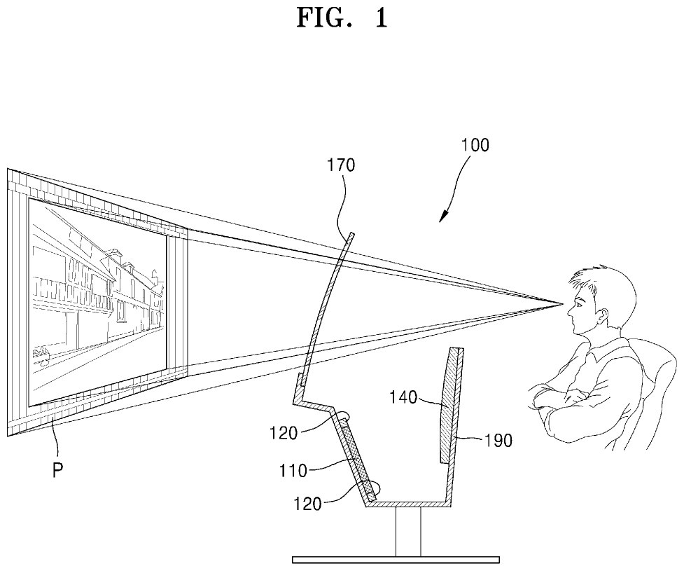

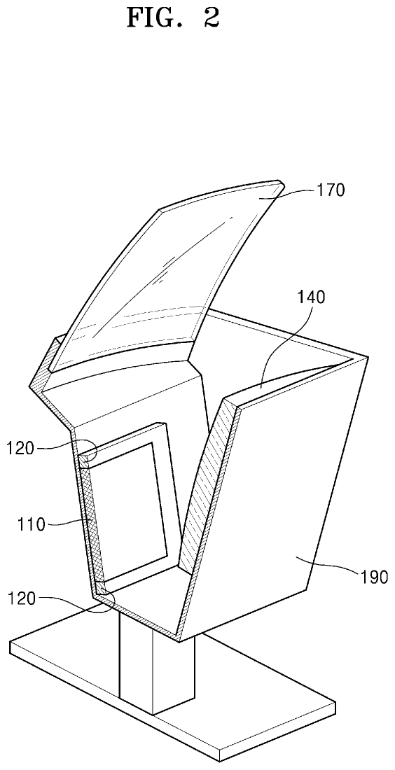

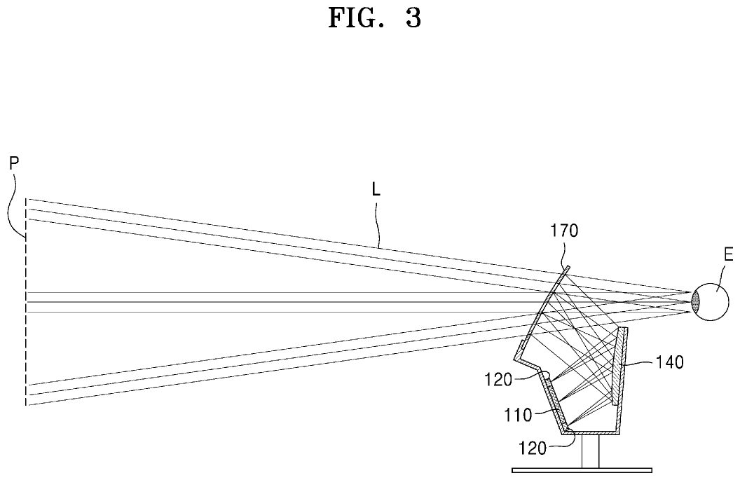

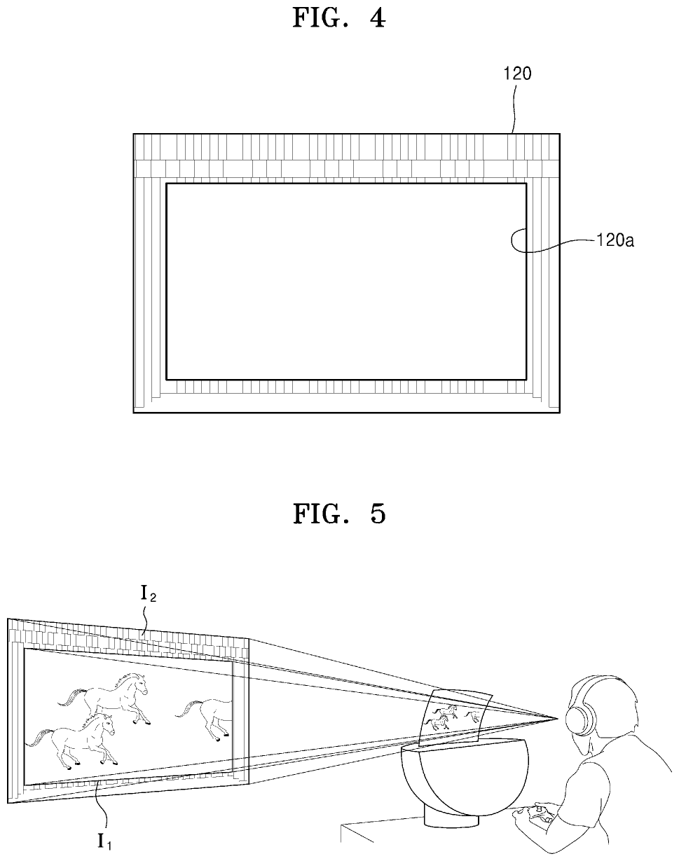

FIG. 1 is a schematic diagram illustrating a display apparatus 100 according to an embodiment of the disclosure, FIG. 2 is a schematic partial cross-sectional view illustrating the display apparatus 100 of FIG. 1, FIG. 3 is a schematic diagram illustrating an optical system of the display apparatus 100 of FIG. 1, and FIG. 4 is a schematic diagram illustrating a surrounding structure 120 according to an embodiment of the disclosure.

Referring to FIGS. 1 to 3, the display apparatus 100 includes an image source 110, the surrounding structure 120, relay optics 140, and a combiner 170. Some of elements of the display apparatus 100 may be integrally combined with the other elements or omitted.

The image source 110 is an apparatus that receives image computer data and outputs an optical image. In an embodiment of the disclosure, the image output from the image source 110 may be a movie, a computer game, a broadcast image, a vehicle navigation image, an aircraft navigation image, etc.

In an embodiment of the disclosure, the image source 110 may include an image panel. The image panel may be, for example, an LCD panel, an OLED panel, an LCoS panel, a DLP panel, etc.

In an embodiment of the disclosure, the image source 110 may be a laser scanning display apparatus. The laser scanning display apparatus may include a laser light source and a scanning apparatus, for example a micro-electromechanical system (MEMS) mirror, a rotation polygon mirror, etc., that scans a laser beam emitted from the laser light source.

In an embodiment of the disclosure, the image source 110 may be a cathode ray tube display apparatus.

The relay optics 140 may be optics that change a size of an image, for example by enlarging or reducing an image output from the image source 110 and transfer the image to the combiner 170. The relay optics 140 may include a lens or a plurality of lenses, a mirror or a plurality of mirrors, or a combination thereof.

The surrounding structure 120 is provided around the image source 110 and has an image of a surrounding object.

In an embodiment of the disclosure, the surrounding structure 120 may be a holder of the image source 110. In other words, the image of the surrounding object may be provided on the holder of the image source 110.

In an embodiment of the disclosure, the surrounding structure 120 may be detachably or fixedly attached to the surroundings of the image source 110.

Referring to FIG. 4, the image of the surrounding object of the surrounding structure 120 may be an image capable of expressing a feeling of size, such as a curtain on the stage. In FIG. 4, the surrounding structure 120 has a hollow 120a with an empty central portion. The hollow 120a of the surrounding structure 120 may have a shape corresponding to a screen of the image source 110. In other words, the surrounding structure 120 may surround a perimeter of the screen of the image source 110. In the embodiment of the disclosure, the surrounding structure 120 surrounds the perimeter of the screen of the image source 110, but is not limited thereto. The surrounding structure 120 may be provided only on a part of the perimeter of the screen of the image source 110.

The relay optics 140 of an embodiment of the disclosure may be a convex mirror that enlarges an image. The convex mirror may be aspherical. The convex mirror may include a glass or plastic material. In the embodiment of the disclosure, the case where one convex mirror is employed as the relay optics 140 is described as an example, but is not limited thereto.

The relay optics 140 of an embodiment of the disclosure may include two or more curved mirrors, a lens or a plurality of lenses, or a combination of at least one lens and at least one mirror.

The combiner 170 is an optical member that forms a virtual image P by reflecting the image transferred from the relay optics 140. In an embodiment of the disclosure, the relay optics 140 and the combiner 170 are arranged such that an object image, for example a formed image, transferred from the relay optics 140 is located inside the focal length of the combiner 170. The combiner 170 may be a partially transparent concave mirror. Here, partial transparency means that part of light is reflected and the other part is transmitted through, and an amount of the transmitted light may vary according to the design and material of a reflective surface of the combiner 170. The reflective surface of the combiner 170 may be aspherical. The combiner 170 may have a curved plate shape. The combiner 170 may include a glass or plastic material. A user E sees the image reflected from the combiner 170 as the virtual image P as though the light were traveling along path L.

The image source 110, the surrounding structure 120, the relay optics 140, and the combiner 170 are installed in a housing 190. The image source 110 and the surrounding structure 120 may be installed on one inner side of the housing 190, and the relay optics 140 may be installed on the other inner side of the housing 190. The combiner 170 may be installed to protrude from the housing 190.

The housing 190 of an embodiment of the disclosure may be installed indoors in the form of a desk top. The user sits on a chair and sees the display apparatus 100 such that the user may have the same experience as sitting in a theater without using virtual reality (VR) glasses.

The housing 190 of an embodiment of the disclosure may be a dashboard of a vehicle or a part of an aircraft cockpit.

FIG. 5 is a schematic diagram illustrating first and second virtual images I₁ and I₂ that a user sees through the display apparatus 100 according to an embodiment of the disclosure. Referring to FIG. 5, the user sees the first virtual image I₁ of an image output from the image source 110 and the second virtual image I₂ formed around the first virtual image I₁ through the display apparatus 100.

The sizes and locations of the first and second virtual images I₁ and I₂ are determined by a virtual image optical system of the display apparatus 100. In an embodiment of the disclosure, the relay optics 140 and the combiner 170 may implement a virtual image magnification of 16 times and a virtual image distance of 10 m. For example, when the image surface diameter of the image source 110 is 10 inches, a virtual image size of 160 inches and the virtual image distance of 10 m may be implemented. However, because a virtual image is not formed on a real space, another object or an obstacle that disturbs the gaze may be present in the location of the virtual image, near the location or in front of the location. In this regard, when the user is deprived of the gaze on such an obstacle, the location of the virtual image may be mistaken as the vicinity of the obstacle. For example, when there is an obstacle in the vicinity of 4 m in front of the display apparatus 100, for example, when a person passes by or when there is an object deprived of the gaze, the user may cause an optical illusion that the virtual image is formed in the vicinity of 4 m in front of the display apparatus 100 and accordingly may recognize the size of the virtual image as reduced as much. The display apparatus 100 of the embodiment of the disclosure prevents such an optical illusion through the second virtual image I₂ formed around the first virtual image Ii. The second virtual image I₂ may be seen by the user in the real surrounding environment, and may be, for example, a stage curtain around the screen as illustrated in FIG. 4. An image, for example the stage curtain, of the surrounding environment of the surrounding structure 120 is formed to have a reciprocal size of magnification of a virtual image optical system with respect to the original size of an image of the surrounding object. In other words, the image of the surrounding environment of the surrounding structure 120 is formed to have a reciprocal size of magnification of the first virtual image I₁ at the virtual image distance of the first virtual image I₁. For example, when the virtual image optical system of the display apparatus 100 has the magnification of 16 times at 10 m, the image of the surrounding environment of the surrounding structure 120 is formed as an image reduced by 16 times an image, for example having the original size, of the real object. For example, in embodiments the image of the surrounding environment of the surrounding structure 120 may be formed as an image having a size that is 1/16th an original size of the real object. When the image of the surrounding environment described above is formed as the second virtual image I₂ by the combiner 170, the image is seen as an image, for example having the size of the real object, enlarged 16 times at a distance of 10 m from the display apparatus 100. By the image of the surrounding environment of the second virtual image I₂ , the user may more easily recognize the sense of scale, for example 160 inches, and suppress the optical illusion caused by the obstacle.

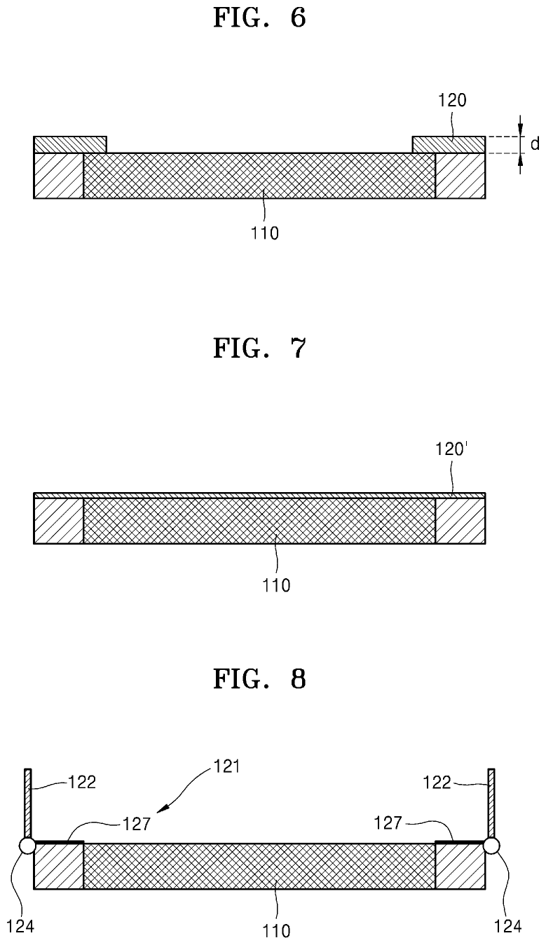

FIG. 6 is a schematic cross-sectional view of the surrounding structure 120 according to an embodiment. Referring to FIG. 6, the surrounding structure 120 may be configured to have a step of a thickness d from a screen of the image source 110. The thickness d may be sub mm to several mm. As such, when the surrounding structure 120 has the step with respect to the image source 110, a user sees the second virtual image I₂ prominently by the step in comparison with the first virtual image I₁, which results in an effect of seeing the real large screen.

FIG. 7 is a schematic cross-sectional view of a surrounding structure 120′ according to an embodiment of the disclosure. Referring to FIG. 7, the surrounding structures 120′ may be continuously formed without a step with respect to a screen of the image source 110. In an embodiment of the disclosure, a surface, for example a surface on which an image of the surrounding environment is provided, of the surrounding structure 120′ and the screen of the image source 110 may be flat. In an embodiment of the disclosure, the surface, for example a surface on which an image of the surrounding environment is provided, of the surrounding structure 120′ may be smoothly curved from the screen of the image source 110. The surface of the surrounding structure 120′ may be formed with the image of the surrounding environment, or may be coated with a black color.

As such, when there is no step between the surrounding structure 120′ and the screen of the image source 110, a boundary between the first virtual image I₁ and the second virtual image I₂ may be ambiguous such that a user may feel a screen in the form of infinity.

FIG. 8 is a schematic cross-sectional view of a surrounding structure 121 according to an embodiment of the disclosure. Referring to FIG. 8, the surrounding structure 121 is a movable surrounding structure configured such that a first mode protruding from a screen of the image source 110 and with a step formed and a second mode continuously formed without a step are switchable. The first mode and the second mode may be changed by a user's selection, or may be automatically changed according to a content attribute of a displayed image.

In an embodiment of the disclosure, the surrounding structure 121 may include a first surrounding structure 122 that is rotatable, and a second surrounding structure 127 that is continuously arranged without a step along with the screen of the image source 110. The first surrounding structure 122 may be automatically opened and closed along hinge 124 by the motor 125. In an embodiment of the disclosure, in the first mode, a first surrounding structure 122 may cover a second surrounding structure 127, and in the second mode, the first surrounding structure 122 may be completely opened at 90 degrees or 180 degrees. In the first mode, when the first surrounding structure 122 covers the second surrounding structure 127, the first surrounding structure 122 may be a stepped surrounding structure as described with reference to FIG. 5. In an embodiment of the disclosure, the surface of the second surrounding structure 127 may be applied in a black color to increase immersion in an image output from the image source 110.

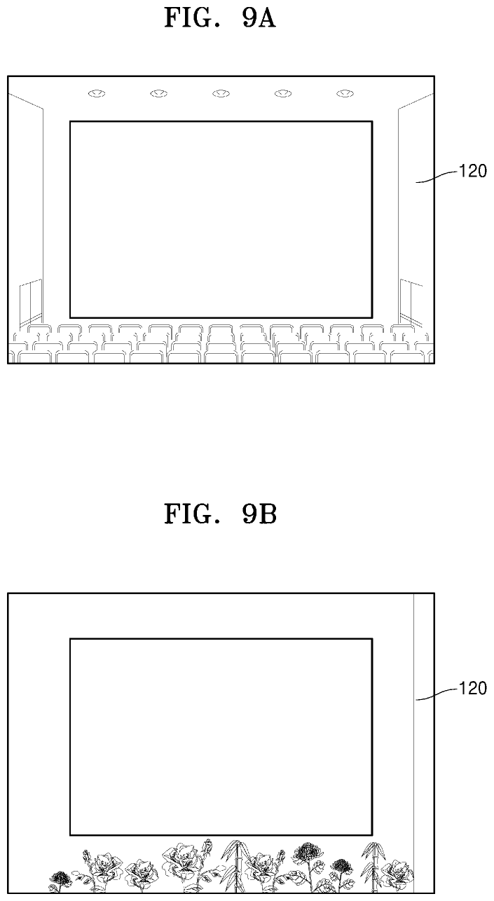

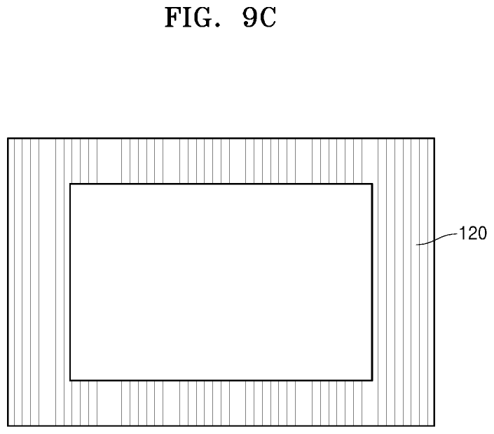

FIG. 9A is a schematic diagram illustrating an image of a surrounding environment of the surrounding structure 120 according to an embodiment of the disclosure. Referring to FIG. 9A, the image of the surrounding environment may be in the shape of an auditorium. A screen of the image source 110 may be located on a stage of the auditorium. Such an image in the shape of the auditorium is formed by being reduced to a reciprocal size of magnification of a virtual image optical system with respect to the size of the real auditorium.

FIG. 9B is a schematic diagram illustrating an image of a surrounding environment of the surrounding structure 120 according to an embodiment of the disclosure. Referring to FIG. 9B, the image of the surrounding environment may be an image such as a flower decoration. Such an image of the flower decoration is formed by being reduced to a reciprocal size of magnification of the virtual image optical system with respect to the size of the real flower decoration.

FIG. 9C is a schematic diagram illustrating an image of a surrounding environment of the surrounding structure 120 according to an embodiment of the disclosure. Referring to FIG. 9C, the image of the surrounding environment may be an image such as a wallpaper pattern. Such an image of the wallpaper pattern is formed by being reduced to a reciprocal size of magnification of the virtual image optical system with respect to the size of the real wallpaper pattern.

The images of the surrounding environment illustrated in FIGS. 4 and 9A to 9C are exemplary, and are not limited thereto. The images of the surrounding environment of the surrounding structure 120 may make it easier to recognize the sense of scale, for example 160 inches. In addition to a virtual image generated by the image source 110, because the image of the surrounding environment of the surrounding structure 120 is seen together, the user may unconsciously compare the image of the surrounding environment and a content image to feel the sense of the virtual image size/distance of the content image as intended by the virtual image optical system. For example, the image of the surrounding environment may be any one of an auditorium shape, a clock, a frame, a tree, a flower pot, a curtain, a person, an animal, a wallpaper, a floor, a block, and a tile, but is not limited thereto.

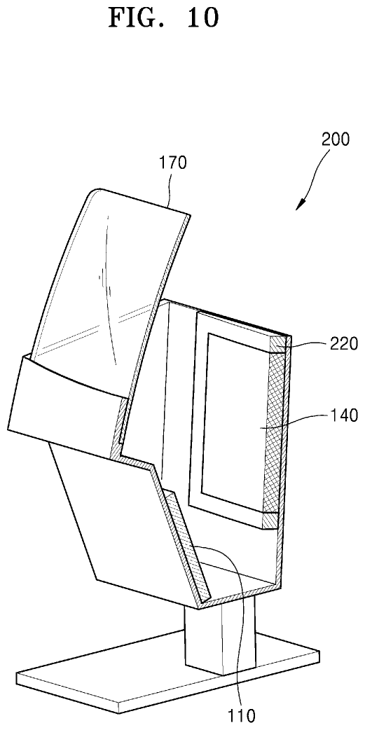

FIG. 10 is a schematic partial cross-sectional view of a display apparatus 200 according to an embodiment of the disclosure.

Referring to FIG. 10, the display apparatus 200 includes the image source 110, a surrounding structure 220, the relay optics 140, and the combiner 170. Some of elements of the display apparatus 200 may be integrally combined with other components or omitted.

The display apparatus 200 of the embodiment of the disclosure is substantially the same as the display apparatus 100 of the embodiment of the disclosure described with reference to FIGS. 1 to 9, except for the location of the surrounding structure 220, and thus differences will be mainly described.

The surrounding structure 220 may be disposed on the relay optics 140 side. In an embodiment of the disclosure, the relay optics 140 may be a convex mirror, and the surrounding structure 220 may be formed to surround the circumference of the convex mirror. The surrounding structure 220 may be a holder of the convex mirror or may be attached to the holder.

In an embodiment of the disclosure, the relay optics 140 may include a plurality of mirrors, or a lens or a plurality of lenses, or a combination thereof such that the surrounding structure 220 may be disposed on any one of these optical members.

An image of the surrounding environment of the surrounding structure 220 may be formed by being appropriately reduced to be viewed as an image, for example a circle size, of a real object at a virtual image distance of the first virtual image

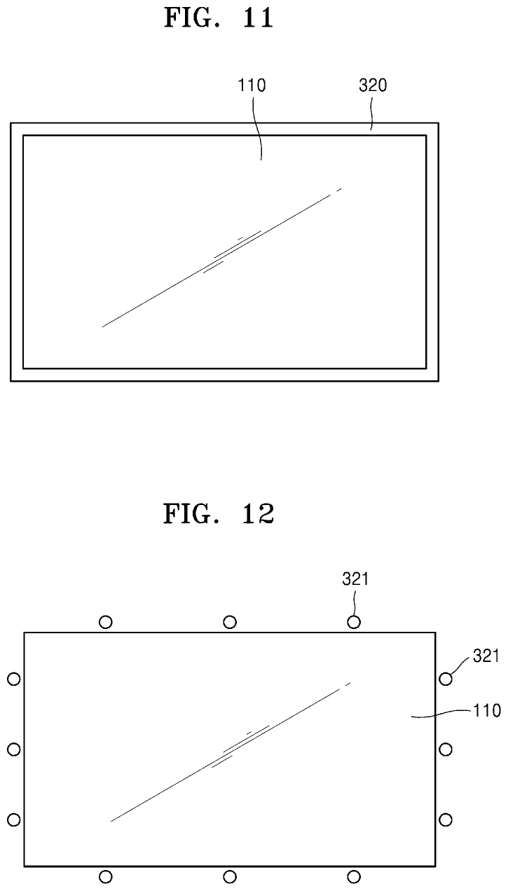

FIG. 11 is a diagram illustrating the image source 110 and a surrounding light source 320 of a display apparatus according to an embodiment of the disclosure.

Referring to FIG. 11, the surrounding light source 320 may be disposed around the image source 110. The surrounding light source 320 may be a linear light source surrounding a screen of the image source 110. For example, the surrounding light source 320 may include a light guide plate surrounding the screen of the image source 110 and a light source supplying light to the light guide plate.

In an embodiment of the disclosure, the surrounding light source 320 may be disposed in place of the surrounding structure 120 of the above-described embodiments of the disclosure.

In an embodiment of the disclosure, the surrounding light source 320 may be disposed along with the surrounding structure 120 of the above-described embodiments of the disclosure.

The surrounding light source 320 may not only clearly express the boundary of the screen of the image source 110 but also produce the effect of increasing immersion when expressing a color associated with a content screen.

FIG. 12 is a diagram illustrating the image source 110 and a surrounding light source 321 of a display apparatus according to an embodiment of the disclosure. Referring to FIG. 12, the surrounding light source 320 may be a plurality of point light sources arranged around a screen of the image source 110.

The surrounding light source 320 of an embodiment of the disclosure may be stage lighting or may have a reduced shape of other surrounding environment image. The shape of the surrounding light source 320 is formed to have a reciprocal size of magnification of a virtual image optical system with respect to the original size of an image of a surrounding object.

When the second virtual image I₂ is formed through the virtual image optical system, the surrounding light source 320 may be recognized by a user as the stage lighting, thereby not only providing a clear sense of scale but also increasing immersion when expressing a color associated with a content screen.

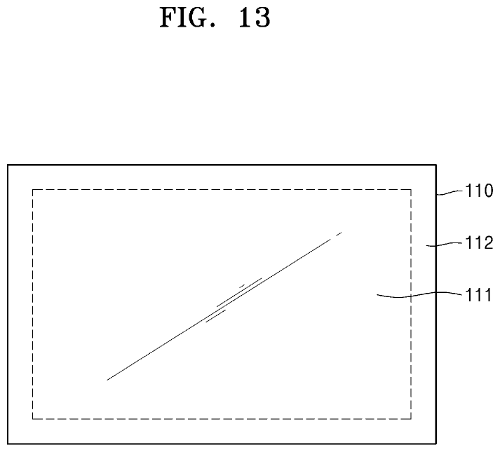

The display apparatuses 100 and 200 of the above-described embodiments of the disclosure use the surrounding structures 120 and 220 or the surrounding light sources 320 and 321, but are not limited thereto. FIG. 13 is a diagram illustrating the image source 110 of a display apparatus according to an embodiment of the disclosure. As illustrated in FIG. 13, a screen of the image source 110 may include a first region 111 displaying content and a second region 112 located around the first region 111 and displaying an image of a surrounding object.

In an embodiment of the disclosure, the first region 111 may be located at the center of the screen of the image source 110, and the second region 112 may surround the perimeter of the first region 111.

In an embodiment of the disclosure, the second region 112 may be located on one side of the first region 111.

The second region 112 may display the image, for example the a stage curtain, of the surrounding object reduced to a reciprocal size of magnification of a virtual image optical system with respect to the original size of the image of the surrounding object.

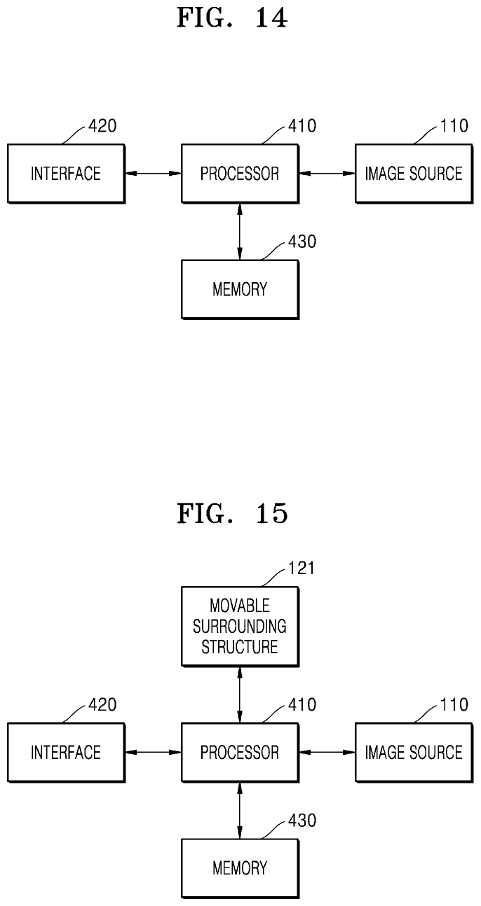

FIG. 14 is a schematic block diagram illustrating the display apparatus 100 according to an embodiment of the disclosure.

Referring to FIG. 14, the display apparatus 100 includes the image source 110, a processor 410, an interface 420, and a memory 430.

The processor 410 may control an overall operation of the display apparatus 100 including the image source 110 by driving an operating system or an application program, and may perform processing and operations on various data including image data. For example, the processor 410 may process image data such as a movie. For example, the processor 410 may drive a program such as a computer game. For example, the processor 410 may drive a program such as navigation. As an example, the processor 410 may drive various simulator programs such as a vehicle, an aircraft, a ship, a mechanical device, etc. The processor 410 may be configured as at least one hardware of, for example, a central processing unit, a microprocessor, a graphic processing unit, application specific integrated circuits (ASICs), digital signal processors (DSPs), digital signal processing devices (DSPDs), programmable logic devices (PLDs), or field programmable gate arrays (FPGAs), but is not limited thereto.

The interface 420 is to input/output of data or manipulation commands from the outside, and may include, for example, a user interface such as a touch pad, a controller, an operation button, and a keyboard that are operable by a user. In an embodiment of the disclosure, the interface 420 includes a wired communication module, such as a USB module, a LAN module, or a wireless communication module, such as Bluetooth, and may receive user manipulation information or image data transferred from an external device or network through the communication modules.

The memory 430 may include internal memory such as volatile memory or nonvolatile memory. The memory 430 may store various data, programs or applications that drive and control the display apparatus 100 under the control of the processor 410, and input/output signal or image data.

The image source 110 is configured to receive the image data generated by the processor 410 and generate light of a 2D image, and may be an image panel such as an LCD panel, an OLED panel, an LCoS panel, or a DLP panel, a laser scanning display apparatus or a cathode ray tube display apparatus.

In an embodiment of the disclosure, the processor 410 displays an image of the surrounding environment suitable for the second region 112 of the image source 110 based on a content attribute of an image output from the first region, for example first region 111 of FIG. 13, of the image source 110. For example, when a movie is watched, the image of the surrounding environment may be a surrounding image of a screen of a movie theater.

FIG. 15 is a schematic block diagram illustrating the display apparatus 100 according to an embodiment of the disclosure. Referring to FIG. 15, the display apparatus 100 includes the image source 110, the processor 410, the interface 420, the memory 430, and a movable surrounding structure 121. As described with reference to FIG. 8, a first mode and a second mode of the movable surrounding structure 121 may be changed by a user's selection or may be automatically changed according to a content attribute of a displayed image.

In an embodiment of the disclosure, when there is an obstacle in the surroundings, the first mode in which there is a step of the movable surrounding structure 121 may be selected, and when there is no obstacle in the surroundings, the second mode in which there is no step of the movable surrounding structure 121 may be selected.

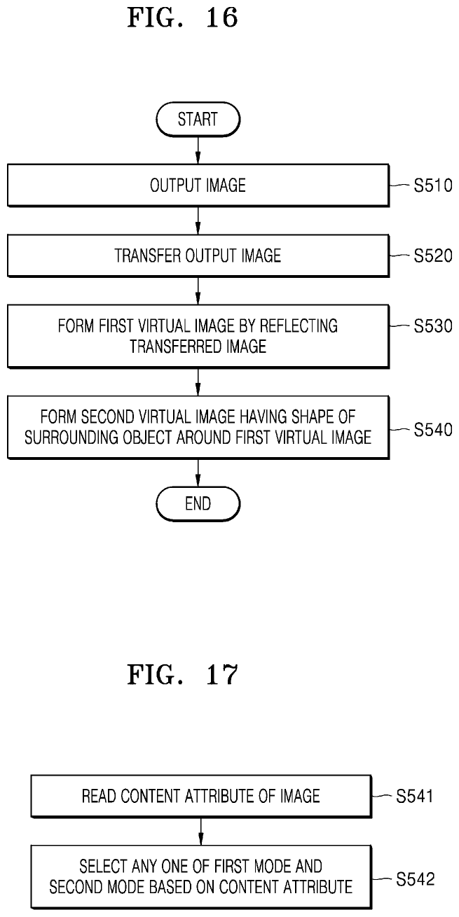

FIG. 16 is a schematic flowchart illustrating a display control method according to an embodiment of the disclosure.

Referring to FIG. 16, a display apparatus according to an embodiment of the disclosure allows the processor 410 to process data received through the interface 420 or stored in the memory 430 and a first region of the image source 110 to output an image at operation S510. The output image is enlarged or reduced through the relay optics 140 and transferred to the combiner 170 at operation S520. The combiner 170 reflects the received image to form a first virtual image at operation S530. The processor 410 processes the data received through the interface 420 or stored in the memory 430 such that a second region of the image source 110 outputs an image of a surrounding environment along with the formation of the first virtual image or sequentially and forms a second virtual image through the relay optics 140 and the combiner 170 at operation S540. The user may maintain the sense of scale of the first virtual image thanks to the second virtual image.

FIG. 17 is a schematic flowchart illustrating a display control method according to an embodiment of the disclosure. Referring to FIG. 17, an operation of forming a second virtual image may include operation S541 in which the processor 410 reads a content attribute of an image, and operation S542 in which the processor 410 selects any one of a first mode and a second mode of the movable surrounding structure 121 based on the content attribute. A user may directly select any one of the first mode and the second mode of the movable surrounding structure 121.

Although the display apparatuses 100 and 200 described in the disclosure are described as a desktop-top type, those of ordinary skill in the art may clearly understand that the display apparatuses 100 and 200 may be modified as a vehicle HUD or an aircraft HUD

The display apparatuses 100 and 200 described in the disclosure use a principle in which the shape of mechanism around the image source 110 is seen on a virtual image in addition to content created by the image source 110, and thus the user may maintain the sense of scale when watching an image.

According to the disclosure, the display apparatus and the display control method may allow the size and distance of the virtual image determined by the design of a virtual image optical system to be correctly recognized.

While the display apparatus and the display control method have been particularly shown and described with reference to exemplary embodiments thereof, it will be understood by those of ordinary skill in the art that various changes in form and details may be made therein without departing from the spirit and scope as defined by the following claims. Therefore, the scope sought to be protected of the disclosure shall be defined by the appended claims.

What is claimed is:

1. A display apparatus comprising:
an image source configured to output a first image;
a relay optics component configured to change a size of the first image and to transfer the first image;
a surrounding structure provided around the image source or the relay optics component, and comprising a second image of a surrounding object; and
a combiner configured to form a first virtual image by reflecting the first image, and to form a second virtual image around the first virtual image by reflecting the second image.

2. The display apparatus of claim 1, wherein the first virtual image has a first magnification size at a virtual image distance of the first virtual image,
wherein the surrounding structure is provided around a screen of the image source,
wherein the second image has a second magnification size with respect to an original size of the surrounding object, and
wherein the second magnification size is reciprocal to the first magnification size.

3. The display apparatus of claim 2, wherein the surrounding structure is configured to surround a perimeter of the screen of the image source.

4. The display apparatus of claim 1, wherein the image source comprises an image panel, and
wherein the surrounding structure comprises a holder of the image panel.

5. The display apparatus of claim 1, wherein the relay optics component comprises a convex mirror configured to magnify and reflect the first image, and
wherein the surrounding structure comprises a holder of the convex mirror.

6. The display apparatus of claim 5, wherein the surrounding structure is configured to surround a circumference of the convex mirror.

7. The display apparatus of claim 1, wherein the second image comprises an image of any one of a clock, a frame, a tree, a flower pot, a curtain, a person, an animal, a wallpaper, a floor, a block, and a tile.

8. The display apparatus of claim 1, further comprising a surrounding light source configured to emit a surrounding light around the surrounding structure.

9. The display apparatus of claim 1, wherein the surrounding structure comprises a step formed to protrude from a screen of the image source.

10. The display apparatus of claim 1, wherein the surrounding structure is continuously formed without a step with respect to a screen of the image source.

11. The display apparatus of claim 1, wherein the surrounding structure is configured to operate in a first mode of protruding from a screen of the image source with a step and in a second mode of being continuously formed without the step, and
wherein the first mode and the second mode are switchable.

12. The display apparatus of claim 11, wherein the second virtual image comprises a black color while the surrounding structure operates in the second mode.

13. The display apparatus of claim 1, wherein the combiner comprises a partially transparent concave mirror.

14. A display apparatus comprising:
an image source configured to output a first image;
a relay optics component configured to change a size of the first image and transfer the first image;
a surrounding light source provided around the image source or the relay optics component and configured to emit a surrounding light; and
a combiner configured to form a first virtual image by reflecting the first image transferred from the relay optics component; and form a second virtual image around the first virtual image by reflecting the surrounding light.

15. The display apparatus of claim 14, wherein the surrounding light source comprises a plurality of point light sources or continuous line light sources.

16. The display apparatus of claim 14, wherein a shape of the surrounding light source comprises a reduced shape of a surrounding object.

17. A display apparatus comprising:
an image source configured to output an image;
a relay optics component configured to change a size of the image and transfer the image; and
a combiner configured to form a virtual image by reflecting the image,
wherein a screen of the image source comprises a first region configured to display content and a second region located around the first region and configured to display an image of a surrounding object.

18. The display apparatus of claim 17, wherein the first region is located at a center of the screen, and the second region surrounds a perimeter of the first region.

19. The display apparatus of claim 18, wherein a first virtual image of the first region has a first magnification size at a virtual image distance of the first virtual image,
wherein the image of the surrounding object has a second magnification size with respect to an original size of the surrounding object, and
wherein the first magnification size is a reciprocal of the second magnification size .

20. A display control method comprising:
outputting an image;
transferring the image using a relay optics component;
forming a first virtual image by reflecting the image by using a combiner; and
forming a second virtual image comprising a shape of a surrounding object around the first virtual image using the combiner.
